(19) United States
(12) Patent Application Publication
(10) Pub. No.: US 2005/0257016 A1
(43) Pub. Date: Nov. 17, 2005

(54) Digital signal controller secure memory partitioning

(76) Inventors: Brian Boles, Mesa, AZ (US); Sumit Mitra, Tempe, AZ (US); Steven Marsh, Chandler, AZ (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/846,579

(22) Filed: May 17, 2004

(51) Int. Cl. G06F 12/00

(52) U.S. Cl. 711/163

(57) ABSTRACT

A controller offers various security modes for protecting program code and data stored in memory and ensuring that the protection is effective during all normal operating conditions of the controller. The controller includes configuration settings that segment program memory into a boot segment, a secure segment and a general segment, each with a particular level of security including no enhanced protection. The boot code segment (BS) is the most secure and may be used to store a secure boot loader. The secure code segment (SS) is useful for storing proprietary algorithms from third parties, such as algorithms for separating ambient noise from speech in speech recognition applications. The general code segment (GS) has the least security. The controller is configured to prevent program flow changes that would result in program code stored in high security segments from being accessed by program code stored in lower security segments. In addition, the processor may be configured to have associated secure data portions of both program memory, such as flash memory, and random access memory (RAM) corresponding to the BS, SS and GS. Attempts to read data from or write data to the program memory or RAM associated with a higher security level from a lower security level are prevented from occurring.

### FIELD OF THE INVENTION

The present invention relates to systems and methods for protecting, from code or data copying or alteration, one or more segments of memory in a controller chip, such as a microcontroller, microprocessor, digital signal controller or digital signal processor and, more particularly, to systems and methods for inhibiting access to memory segments by programs running in insecure areas of memory.

### BACKGROUND OF THE INVENTION

Controllers, such as microcontrollers, microprocessors, digital signal controllers and digital signal processors conventionally are structured to be programmable to perform particular applications and functions within a system. Generally, these devices have been programmable without restriction by the customer or programmed during the manufacturing process with software provided by or specified by the customer. Thus, the code in controllers has conventionally been accessible, by design, by the customer with little if any security preventing access by the customer.

With the increasing density and storage capacity of controller devices, it has become desirable to provide the flexibility to store third party software and data in the program memory of controllers that are to be distributed to customers, together with any customer software programmed at the time of manufacture or at a later time. For this type of application, the customer is no longer a trusted party relative to the third party software. Accordingly, there is a need to protect the third party software and data from discovery by the customer. This is particularly true for software and data such as encryption algorithms and encryption keys. It is also true for third party software of other types, such as algorithms for performing digital signal processing functions that add value to chips but at the same time represent software protected by copyright and in some cases trade secret. It is also true for start up software such as boot programs, boot loaders and operating systems which in addition to being proprietary need access restrictions in order to ensure that they are executed as stored without alteration to ensure the security of the system in which the controller is operating.

Accordingly, there is a need for a controller design that allows the security of memory to be enhanced. There is a further need for a controller design that allows certain areas of memory to be more secure than other areas. There is still a further need for a controller design that monitors the program flow and prevents the controller for entering secure areas of memory under certain circumstances and that prevents the controller from reading and writing to secure areas of memory.

### SUMMARY OF THE INVENTION

According to the present invention, a controller is provided that offers various security modes for protecting program code and data stored in memory and ensuring that the protection is effective during all normal operating conditions of the controller. The controller includes configuration settings that segment program memory into a boot segment, a secure segment and a general segment, each with a particular level of security including no enhanced protection. The boot code segment (BS) is the most secure and may be used to store a secure boot loader. The secure code segment (SS) is useful for storing proprietary algorithms from third parties, such as algorithms for separating ambient noise from speech in speech recognition applications. The general code segment (GS) has the least security.

The controller is configured to prevent program flow changes that would result in program code stored in the BS from being accessed by program code stored in the SS or GS. Similarly, the controller is configured to prevent program code stored in the SS from being accessed by program code stored in the GS. When a violation occurs, the controller executes a trap routine and may reset the processor or otherwise prevent the security breach from occurring. In addition to preventing program flow changes from lower security code to higher security code, the processor may be configured to have associated secure data portions of both program memory, such as flash memory, and random access memory (RAM) corresponding to the BS, SS and GS. Attempts to read data from or write data to the program memory or RAM associated with a higher security level from a lower security level are prevented from occurring. In this manner, secure program code and data associated with different segments of memory may be protected from discovery by users of the controller, while making the functionality of the secure program code available to the user.

### BRIEF DESCRIPTION OF THE FIGURES

The above described features and advantages of the present invention will be more fully appreciated with reference to the detailed description and appended figures in which:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIGS. 3A-3C depicts segments of program memory according to an embodiment of the present invention.

FIG. 4 depicts security configuration registers according to an embodiment of the present invention.

FIG. 5 depicts function block diagram for preventing program flow changes that violate security according to an embodiment of the present invention.

FIG. 6 depicts a functional block diagram for preventing access to secured areas of memory according to an embodiment of the present invention.

### DETAILED DESCRIPTION

According to the present invention, a controller is provided that offers various security modes for protecting program code and data stored in memory and ensuring that the protection is effective during all normal operating conditions of the controller. The controller includes configuration settings that segment program memory into a boot segment, a secure segment and a general segment, each with a particular level of security including no enhanced protection. The boot code segment (BS) is the most secure and may be used to store a secure boot loader. The secure code segment (SS) is useful for storing proprietary algorithms from third parties, such as algorithms for separating ambient noise from speech in speech recognition applications. The general code segment (GS) has the least security.

The controller is configured to prevent program flow changes that would result in program code stored in the BS from being accessed by program code stored in the SS or GS. Similarly, the controller is configured to prevent program code stored in the SS from being accessed by program code stored in the GS. When a violation occurs, the controller executes a trap routine and may reset the processor or otherwise prevent the security breach from occurring. In addition to preventing program flow changes from lower security code to higher security code, the processor may be configured to have associated secure data portions of both program memory, such as flash memory, and random access memory (RAM) corresponding to the BS, SS and GS. Attempts to read data from or write data to the program memory or RAM associated with a higher security level from a lower security level are prevented from occurring. In this manner, secure program code and data associated with different segments of memory may be protected from discovery by users of the controller, while making the functionality of the secure program code available to the user.

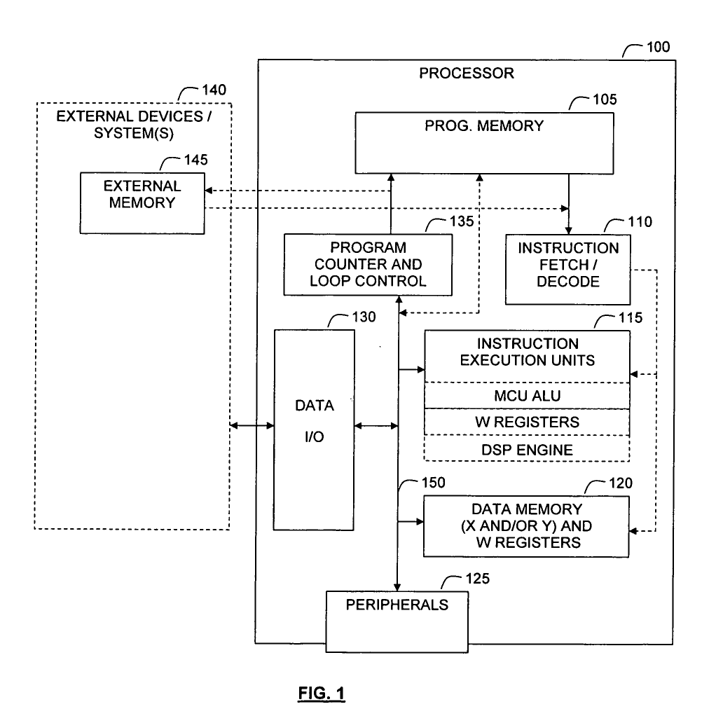

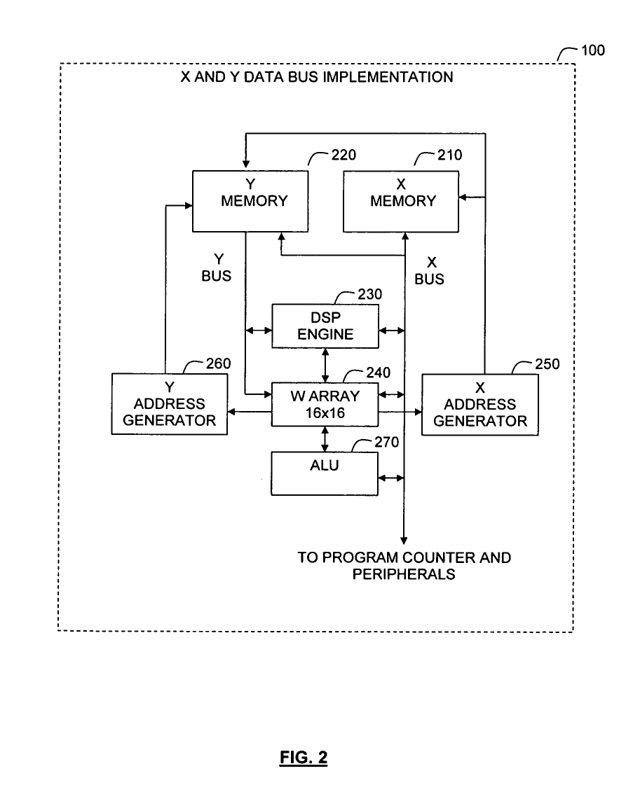

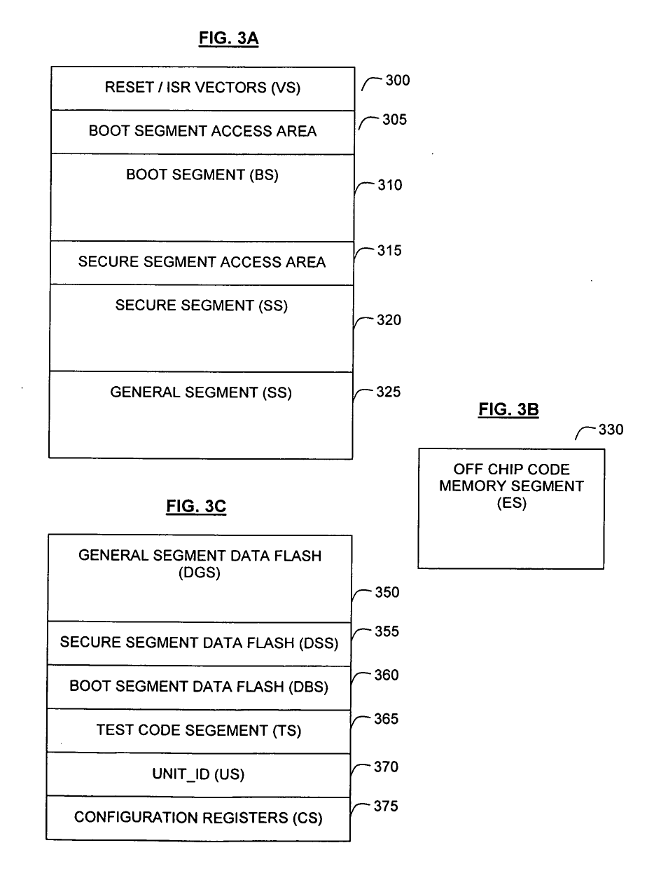

In order to describe embodiments of controllers incorporating security features according to the present invention, an overview of pertinent processor elements is first presented with reference to FIGS. 1 and 2. The systems and methods for implementing enhanced security according to the present invention are then described more particularly below with reference to FIGS. 3-6.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-circuit serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:
Q1: Fetch Instruction
Q2: Fetch Instruction
Q3: Fetch Instruction
Q4: Latch Instruction into prefetch register, Increment PC

The following sequence of events may comprise, for example, the execute instruction cycle for a single operand instruction:
Q1: latch instruction into IR, decode and determine addresses of operand data
Q2: fetch operand
Q3: execute function specified by instruction and calculate destination address for data
Q4: write result to destination

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.
Q1: latch instruction into IR, decode and determine addresses of operand data
Q2: pre-fetch operands into specified registers, execute operation in instruction
Q3: execute operation in instruction, calculate destination address for data
Q4: complete execution, write result to destination
   Secure Partitioning

FIGS. 3A-3C depict an organization of non-volatile memory for a controller according to an embodiment of the present invention. FIG. 3A depicts an embodiment of the program memory. Referring to FIG. 3A, the program memory includes a reset and interrupt service routine (ISR) vector area 300, a boot segment access area 305, a boot segment 310, a secure segment access area 315 a secure segment 320 and a general segment 325.

The vector area 300 may be configured to store program address vectors to interrupt service routines that are invoked when a security violation occurs. It may be located anywhere in the program memory, including in the first 128 instruction words of the program memory. The vector area 300 may be configured using a configuration bit to allow or to not allow writes when the controller is in a high security mode or to allow writes in lower security modes.

The boot segment 310 and boot segment access area 305 comprise the most secure segments within the program memory. Each stores program instructions which may comprise, for example, a boot loader program or an operating system depending on the size of the segments. The boot segment access area 305 may comprise a subset of the boot segment 310 and, in a high security mode, may comprise an address range into which program flow control changes are allowed from less secure segments of memory for executing subroutine calls to the boot segment, such as from the secure segment, general segment or external memory. In this manner, access to the boot segment can be further controlled and handled according to security procedures embodied in instructions stored in the boot segment access area. Reading and writing the contents of boot segments 305 and 310 may also be restricted depending on the security configuration of the controller. Program instructions for the boot segments 305 and 310 may be programmed into the program memory during manufacture of the chip or subsequent to manufacture. The configuration bits of the controller may also be programmed to prevent a user of the controller from discovering the program instruction in the boot segments, changing the program instructions in the boot segment or executing program instructions in the boot segments without invoking allowed boot segment subroutines or booting the controller.

The secure segment 320 and the secure segment access area comprise another secure segment within the program memory. Each stores program instructions which may comprise, for example, third party software such as useful library of functions or algorithms that may be called by users of the controller in general program code that that the controller is programmed to execute. The size of the secure segments 320 and 315 and their existence depend on the settings of the configuration bits. The secure segment access area 315 may comprise a subset of the secure segment 320 and, in a high security mode, may comprise an address range into which program flow control changes are allowed from less secure segments of memory for executing subroutine calls to the secure segment, such as from the general segment or external memory. In this manner, access to the secure segment can be further controlled and handled according to security procedures embodied in instructions stored in the secure segment access area. The boot segment may be configured to access the secure segments without restriction. Reading and writing the secure segments 315 and 320 may also be restricted depending on the security configuration of the controller. Program instructions for the secure segments 305 and 310 may be programmed into the program memory during manufacture of the chip or subsequent to manufacture. The configuration bits of the controller may also be programmed to prevent a user of the controller from discovering the program instruction in the secure segments, changing the program instructions in the boot segment or executing program instructions in the secure segments without invoking allowed secure segment subroutines or booting the controller. In this manner, program code provided by third parties and embodied in a controller may be protected from discovery by users of the controllers even as the users of the controllers use the functionality of the third party code embodied in the controller.

The general segment 325 may have a lower security level than the secure segments and the boot segments. The general segment may store program instructions that comprise, for example, user software such as system level programs and routines that cause the controller to operate within a larger system. The size of the general segments 325 and its existence depends on the settings of the configuration bits. The general segment 325 typically stores the majority of the program instructions. The boot segment and secure segment may be configured to access the general segment without restriction. Reading and writing the general segment 325 may also be restricted depending on the security configuration of the controller. Program instructions for the general segment 325 may be programmed into the program memory during manufacture of the chip or subsequent to manufacture. The configuration bits of the controller may also be programmed to prevent a user of the controller from discovering the program instruction in the general segment, changing the program instructions in the general segment or executing program instructions in the general segments. In this manner, program code provided in the general segment may be protected from discovery by users of the controllers.

FIG. 3B depicts external memory as an external segment (ES) 330. The external segment 330 may store program instructions designed to operate within the secure controller according to embodiments of the present invention. The ES has the lowest security level and may be configured so that it cannot jump to or call a routine in the BS or SS directly. Rather, the ES may only jump to or call a routine in the GS.

FIG. 3C depicts a non-volatile section of data memory. It may include a general segment data section 350, a secure segment data section 355, a boot segment data section 360, a test code segment 365, a unit_ID section 370 and a configuration registers section 375. The general segment data section 350 may be configured to create a section of data required by the general code segment 325. When present, the data in section 350 may be protected from being read from or written to by code stored in an unprotected or less protected area of, memory such as the external segment 330.

The secure segment data section 355 may be configured to create a section of data required by one or more secure code segments 320. When present, the data in section 355 may be protected from being read from or written to by code stored in an unprotected or less protected area of memory such as the general segment 325 or the external segment 330. The data may be useful constants, coefficients, encryption keys or other useful data.

The boot segment data section 360 may be configured to create a section of data required by the boot code segments 310. When present, the data in section 360 may be protected from being read from or written to by code stored in an unprotected or less protected area of memory such as the secure segment 320, the general segment 325 or the external segment 330. The data may be useful constants, coefficients, encryption keys or other useful data.

The test code segment 365 may store code used to test the operation of the controller. The unit_ID section 370 may be used to store information pertaining to a particular controller, such as a part number, a lot number, a manufacturer number, a manufacturing parameters, a serial number or other unique identifier and any other useful information.

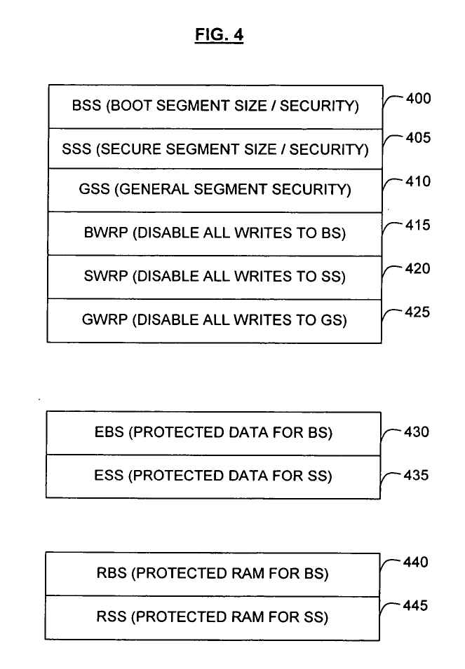

The configuration registers 375 may be used to store security settings for the controller that determine presence, size and level of security associated with each of the segments of memory. FIG. 4 depicts an illustrative set of configuration registers that may be used according to an embodiment of the present invention. The configuration registers may be hard-wired during manufacture of the part, or programmed during manufacture or subsequent thereto.

Referring to FIG. 4, the configuration registers may include the following. A boot segment size/security register 400, a secure segment size/security register 405, a general segment size/security register 410. Each of these registers may be any convenient size and convey to the controller information about whether any of these security segments should be created, and if any is to be created the corresponding size and its level of security. According to one embodiment of the invention, the registers 400-405 includes three bits that define seven settings. For the boot segment:
1—No boot segment
2—383 instruction word boot segment with standard security
3—383 instruction word boot segment with high security
4—1839 instruction word boot segment with standard security
5—1839 instruction word boot segment with high security
6—3867 instruction word boot segment with standard security
7—3867 instruction word boot segment with high security

For the security segment:
1—No security segment
2—3584 instruction word security segment with standard security
3—3584 instruction word security segment with high security
4—6144 instruction word security segment with standard security
5—6144 instruction word security segment with high security
6—12228 instruction word security segment with standard security
7—12228 instruction word security segment with high security
   The boot segment may begin immediately after the Reset and ISR segment or alternatively may be positioned in another part of non-volatile memory. The security segment may begin immediately after the boot segment or alternatively may be positioned in another part of non-volatile memory. Additionally, any number of bits may be used for the registers 400 to 405 to specify the size of one or more the segments, its location in memory and/or corresponding security levels.

The general segment may be configured in exactly the same manner as the secure segment and the boot segment. Alternatively, the general segment may be configured to comprise in size the remaining portion of the non-volatile program memory not occupied by the boot segment and the secure segment. In the latter case, the general segment security bits may be configured using two bits to define three modes:
1—No protection
2—protection level standard
3—protection level high.

The BWRP register 415 is a write enable/disable register. By setting this register to a one or a zero, the controller may be configured to disable all data writes into the boot segment such that the code in the boot segment may not be overwritten. The SWRP register 420 and the GWRP registers 425 are also a write enable/disable register. By setting these registers to a one or a zero, the controller may be configured to disable all data writes into the secure segment and the general segment respectively such that the code in the boot segment may not be overwritten.

The EBS and ESS registers, 430 and 435 respectively, store values that may correspond to the presence, size and location of the boot segment data and secure segment data within the data non-volatile memory of the controller. These areas generally will not be created unless corresponding boot segment and secure segments have been created in the program memory and are accessible only by those corresponding segments. The location of the data within the memory may be predetermined as part of the manufacturing of the data with specific bits to either allocate that predetermined portion of the memory to the boot segment or the security segment or to make it available for other uses. Once allocated, unauthorized read of a protected area of memory from an unauthorized segment will read as a zeros or ones or some other value that does not reflect the actual value of the data. An unauthorized write of a protected area of memory from an unauthorized segment will not initiate a programming sequence and will result in one or more no operation (NOP) cycles. Alternatively, a trap routine may be invoked.

The RBS and RSS registers, 440 and 445 respectively, store values that may correspond to the presence, size and location of the boot segment data and secure segment data within the random access memory of the controller. These areas generally will not be created unless corresponding boot segment and secure segments have been created in the program memory and may be accessible only by those corresponding segments. The location of the data within the memory may be predetermined as part of the manufacturing of the data with specific bits to either allocate that predetermined portion of the memory to the boot segment or the security segment or to make it available for other uses. Once allocated, unauthorized read of a protected area of memory from an unauthorized segment will read as a zeros or ones or some other value that does not reflect the actual value of the data. An unauthorized write of a protected area of memory from an unauthorized segment will not initiate a programming sequence and will result in one or more no operation (NOP) cycles. Alternatively, a trap routine may be invoked. Code stored in the boot segment and the secure segment may change the values in the RBS and RSS registers to release protected corresponding RAM segments when they are no longer needed.

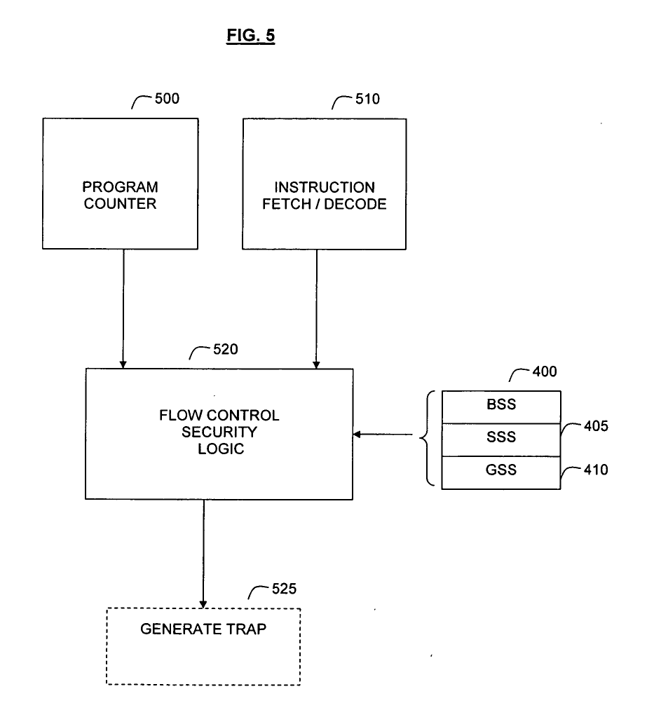

FIG. 5 depicts an embodiment of security logic for monitoring the processing flow of the controller and implementing security measures when the processing flow change occurs that would result in a security violation. This may generally occur in the following ways: a jump or call from a less secure area of program memory, such as the general segment, into a more secure area of memory such as the boot segment or the secure segment; an interrupt vector from a less secure area of program memory into a more secure area of memory; a normal increment of the program counter that results in a transition in the instructions being executed by the controller from a less secure area of program memory into a more secure area of program memory.

Referring to FIG. 5, security for unauthorized program flow changes is implemented using flow control security logic 520. The flow control security logic receives input from the program counter 500 and instruction fetch/decode logic 510 within the controller core. It also receives input from the configuration registers BSS 400, SSS 405 and GSS 410 which specify the size and locations within program memory of the boot segment, secure segment and general segment. During normal operation of the controller, the values in the program counter are incremented in successive processor cycles and the instruction fetch/decode unit fetches the program instruction specified by the address value stored in the program counter. The instructions are in turn executed in successive clock cycles (although execution may occur in parallel) by one of the execution units of the controller. At any given time, the instruction stream being executed will reside in one secure area of memory, such as for example the general segment. Some program instructions will result in a processing flow change by writing a new value in the program counter. Examples are a jump instruction and a subroutine call instruction.

The flow control security logic generates a trap flag based on its inputs whenever a change in the program counter 500 results in the processor attempting to fetch and execute instructions corresponding within a segment having a higher level of security than the segment corresponding to the instruction stream that it is presently processing. Accordingly, the flow control security logic 520 compares the program memory address stored as the current value of the program counter 500 with registers 530-540 and the instructions being executed to determine the current level of security (i.e. boot, secure or general). The flow control security logic 520 also compares the program memory address stored as the next value of the program counter 500 with registers 530-540 and the instructions being executed to determine the level of security (i.e. boot, secure or general) of the next sequential program instruction for execution. Based on these comparisons, the flow control security logic generates a trap flag 525 whenever the program counter is changed to point into a higher security segment from a lower security segment.

An exception to this method of operation occurs when a general segment calls a subroutine within a segment having a higher level of security. This may occur, for example, when the general segment calls a subroutine, such as a third party algorithm, within the secure segment, or calls a subroutine such as an encryption subroutine within the boot segment. In these scenarios, the flow control security logic may allow the program flow change to occur based on the type of instruction, call instruction, and the value of the program counter address change being within a predetermined range, such as the program secure segment access area 315 or the boot segment access area 305.

When a trap flag 525 is generated, it results in the processor jumping to the corresponding trap routine. According to an embodiment of the present invention, the trap routine is a controller reset routine stored in the first 128 bits of the program memory. It will be understood, however, that this trap routine may be stored anywhere within the program memory.

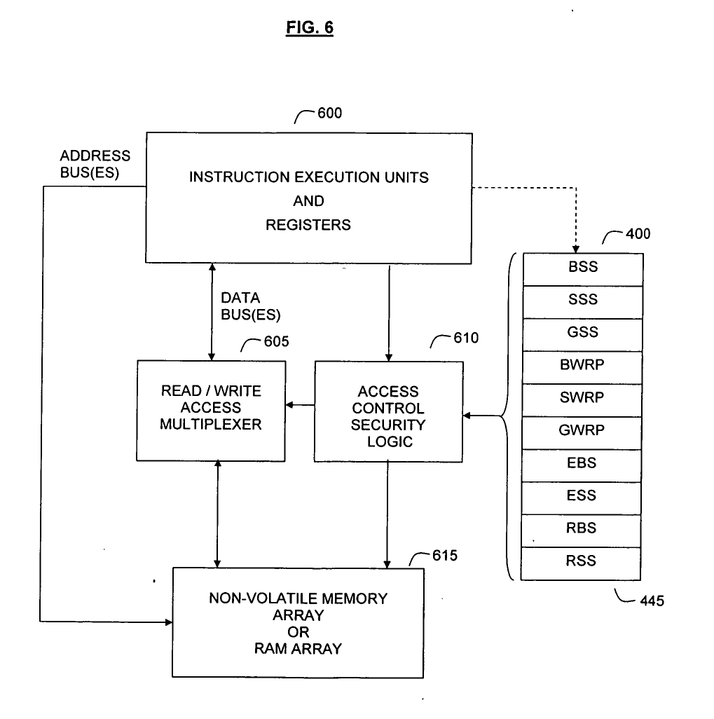

FIG. 6 depicts an embodiment of security logic for monitoring accesses to memory of the controller and implementing security measures when the access would result in a security violation. This may generally occur in the following ways: an attempted read of a secure memory location by program instructions residing within a less secure area of program memory or an attempted write of a secure memory location by a program instruction residing within a less secure area of program memory.

Referring to FIG. 6, the memory access control logic 610 is inserted in a path between the instruction execution units and registers 600 and the memory 615, which may include non-volatile memory and/or random access memory (RAM). The memory arrays 615 is shown as a single functional unit. However, it will be understood that the memory arrays for non-volatile memory and RAM will be physically separate and will be addressed separately over separate address buses when both are present.

The instruction execution units and registers are coupled to the memory array(s) 615 via one or more addresses buses depending on the number of data buses and the number of memory arrays that may be accessed by the controller. The data bus(es) are coupled between the instruction execution units and registers 600 and a read/write access multiplexer. The read/write access multiplexer is used to read data from the array and put it on the appropriate data bus and to write data to the array from the appropriate data bus.

The access control security logic 610 is coupled between the configuration registers 400-445 and the read/write access multiplexer. When a read or a write of a memory array is attempted, the access control security logic 610 determines the security level corresponding to the instruction, which is generally be boot, secure or general according to an embodiment of the present invention although additional security designations may be included. The security level is determined based on the memory address of the instruction as specified by the instruction and corresponding security level of that location.

On an attempted read or write of the memory array, the access control security logic determines whether the read or write is associated with a memory location that (is not permitted to be written according to the BWRP, SWRP, GWRP registers or whether the read or write is associated with a memory location that is associated with a higher level of security than the security level of the read/write instruction. In either case, the access control security logic generates a signal to the read/write access multiplexer that prevents it from performing the read or write operation. Instead, the read/write access multiplexer blocks a write operation resulting in a NOP or forces known data, such as all zeros or all ones on the data bus for an unauthorized read.

While particular embodiments of the present invention have been illustrated and described, it will be understood by those having ordinary skill in the art that changes may be made to those embodiments without departing from the spirit and scope of the invention. For example, the present invention may be applied to a microprocessor, microcontroller, digital signal processor or a hybrid, such as a digital signal controller and to any segments of memory on such chips.

1. A controller for protecting code in memory, comprising:
configuration bits that define a plurality of segments of program memory including a boot code segment and a secure code segment; and
security logic coupled to the configuration bits for preventing accessing protected segments resulting from program flow changes originated by code executed from another memory segment.

2. The controller according to claim 1, wherein the security logic prevents access to the boot code segment resulting from program flow changes originated by code executed from other segments.

3. The controller according to claim 2,
wherein the configuration bits further define a general code segment; and
wherein the security logic prevents access to the secure code segment resulting from program flow changes originated by code executed from the general code segment.

4. The controller according to claim 3,
wherein the configuration bits further define boot segment protected data in non-volatile memory.

5. The controller according to claim 4, wherein the configuration bits further define secure segment protected data in non-volatile memory.

6. The controller according to claim 5, wherein the configuration bits further define boot segment protected data in random access memory.

7. The controller according to claim 6, wherein the configuration bits further define secure segment protected data in random access memory.

8. The controller according to claim 6, further comprising memory access control logic that prevents access to the boot segment.

9. A processor for protecting code in memory, comprising:
configuration bits that define a plurality of segments of program memory including a boot code segment and a secure code segment; and
security logic coupled to the configuration bits for preventing accessing protected segments resulting from program flow changes originated by code executed from another memory segment.

10. The processor according to claim 9, wherein the security logic prevents access to the boot code segment resulting from program flow changes originated by code executed from other segments.

11. The processor according to claim 10,
wherein the configuration bits further define a general code segment; and
wherein the security logic prevents access to the secure code segment resulting from program flow changes originated by code executed from the general code segment.

12. The processor according to claim 11,
wherein the configuration bits further define boot segment protected data in non-volatile memory.

13. The processor according to claim 12, wherein the configuration bits further define secure segment protected data in non-volatile memory.

14. The processor according to claim 13, wherein the configuration bits further define boot segment protected data in random access memory.

15. The processor according to claim 14, wherein the configuration bits further define secure segment protected data in random access memory.

16. The processor according to claim 15, further comprising memory access control logic that prevents access to the boot segment.

17. A method for protecting code in a processor memory, comprising:
detecting a program flow change; and
preventing access to a protected segment of memory by program code executed from a segment having a different security level.

18. The method according to claim 17, further comprising configuration bits that define a plurality of memory segments and their level of security.

19. The method according to claim 18, wherein the protected segment of memory includes program code.

20. The method according to claim 18, wherein the protected segment of memory includes data.
